(19) United States
(12) Patent Application Publication
(10) Pub. No.: US 2015/0239671 A1
(43) Pub. Date: Aug. 27, 2015

(54) Transport system and method for transporting hanging goods

(71) Applicant: Dürkopp Fördertechnik GmbH, Bielefeld, DE (US)

(72) Inventors: Michael WEND, Bielefeld (DE); Paul JANZEN, Bielefeld (DE)

(21) Appl. No.: 14/629,707

(22) Filed: Feb. 24, 2015

(30) Foreign Application Priority Data
Feb. 24, 2014 (DE) 10 2014 203 239.3

(51) Int. Cl. B65G 17/20; B65G 9/00

(52) U.S. Cl. CPC B65G 17/20; B65G 9/002; B65G 9/008

(57) ABSTRACT

The invention relates to a transport system for transporting hanging goods, the transport system comprising a transport means defining a transport direction, several holding members transportable at the transport means in the transport direction for accommodating hanging goods, and at least one separating unit for separating the holding members. The separating unit has at least one separating means, wherein the holding members are movable, by means of the separating unit, in the transport direction from an undefined configuration into a separated configuration in which there is a predefined distance between the two adjacent holding members. The second distance is greater than the first distance. One separating means interacts with in each case at least one holding member for moving the same from an undefined configuration into the separated configuration.

### CROSS-REFERENCE TO RELATED APPLICATIONS

This application claims the priority of German Patent Application No. 10 2014 203 329.3 filed on 24 Feb. 2014, pursuant to 35 U.S.C. (a)-(d), the content of which is incorporated herein in its entirety as if fully set forth herein.

### FIELD OF THE INVENTION

The invention relates to a transport system and to a method for transporting hanging goods, in particular pieces of clothing provided on clothes hangers.

### BACKGROUND OF THE INVENTION

Conveyor systems for the automated conveyance of hanging goods are basically known. Known conveyor systems substantially comprise an accumulation zone and a conveyor zone. In the accumulation zone, the hanging goods are accumulated so as to have a small first distance relative to each other in the transport direction. The hanging goods transported along the conveyor zone have a second distance from each other oriented in a transport direction. Separating units are known by means of which hanging goods can be separated from each other between the accumulation zone and the conveyor zone. Separating units allow the distance between two adjacent hanging goods to be increased. Increasing the distance between two hanging goods has previously been carried out using a pneumatically driven linear reciprocating movement of a separating means in a direction transverse to the transport direction of the hanging goods, wherein a piece of goods accumulated in the accumulation zone being retained by means of known separating means until a sufficient distance from an already released piece of goods adjacent thereto in the transport direction is obtained. Such linear movement of the separating means is however limited physically as well as in terms of a maximum noise level.

### SUMMARY OF THE INVENTION

An object of the present invention is to improve a transport system for transporting hanging goods in such a way that a separating performance is increased considerably while ensuring a reliable operation at the same time.

This object is achieved by a transport system for transporting hanging goods, comprising a transport means defining a transport direction, several holding members transportable at the transport means in the transport direction, said holding members being configured as hanging adapters for accommodating hanging goods, and at least one separating unit for separating the holding members, wherein the separating unit has at least one separating means, wherein in each case one separating means interacts with at least one holding member for moving the same from an undefined configuration into a separated configuration, and wherein in the separated configuration, there is a predefined distance between two adjacent holding members. A transport system for transporting hanging goods comprises a transport means defining a transport direction, several holding members transportable at the transport means in the transport direction, said holding members being configured as hanging adapters for accommodating hanging goods, in particular one piece of goods each, and at least one separating unit for separating the holding members from each other. The holding members are in particular configured as roller adapters as known per se from DE 10 2005 006 455 A1. In other words, the essential feature is that the transport system allows the holding members themselves to be separated from each other. One holding member carries at least one, in particular exactly one, clothes hanger. By means of the holding members, the clothes hangers are indirectly separated from each other. It is not necessary to directly separate the clothes hangers from each other. The transport system has a simple design. The transport system is in particular independent of a particular design of the clothes hangers, in particular the width and/or height thereof. The holding members are in particular each configured identically, each having a size known in advance. Handling the holding members known in advance may be sturdy, in other words fail-safe, and can be performed at an increased throughput rate. The separating unit has at least one separating member, the separating unit thus allowing the holding members to be moved from an undefined configuration in which there is a first, in particular unknown, distance between two adjacent hanging goods into a separated configuration in which there is a second, predefined distance between the two adjacent hanging goods. The predefined distance may be adjustable. This means that the predefined second distance may be changed, for instance depending on the goods to be transported and/or the holding members. The predefined distance is in particular obtained as a result of an arrangement of the at least one separating means in the separating unit. Due to the fact that the second distance is a predefined distance, the holding members are in a defined position while being separated in the separating unit, and are in particular arranged at equal distances from each other. The distance between the holding members is predefined and known. This in particular facilitates the identification of the holding members and/or the hanging goods attached thereto. Separating the holding members by means of the separating means provides a simple and uncomplicated solution for performing the separating process. The separating performance is increased. The second distance may be greater than the first distance. In particular, the first distance is unknown and in particular irregular. The first distance between the holding members when arranged in front of the separating unit substantially depends on the hanging goods secured to the holding members. If hanging goods are attached to the holding members such that their respective thickness is in each case oriented parallel to the transport direction, then the holding members are in each case arranged at different, in other words undefined and in particular unknown, first distances from each other. In other words, the essential feature is that the holding members, which are previously arranged in the undefined configuration with unknown distances between two adjacent holding members are separated from each other by the transport system according to the invention in such a way that a distance between two adjacent holding members is identical during the separating process. The identical distance is in particular adjustable irrespective of the hanging goods transported by the holding members. The separating unit in particular allows a first holding member to be conveyed actively. To this end, the holding member is transported by means of the separating means of the separating unit. At the same time, a second holding member arranged such as to follow the first holding member is retained in the separating unit. Said second holding member is retained until it is transported by means of a separating means, provided for this purpose, of the separating unit. The separating unit has a transport function. The separating unit has a retaining function. Due to the fact that a separating means interacts with a holding member such that the latter is moved from an in-line configuration into a separated configuration, the separation process can be performed during a continuous transport of the holding members, a separation performance being adjustable by actuating the separating unit in a defined manner, in particular by increasing a speed of the at least one separating member. Advantageously, more than one separating means is provided, the separating means moving periodically so as to interact consecutively with in each case one holding member for moving the latter from the in-line configuration into the separated configuration. Advantageously, the separating unit is configured such that the separating means move continuously relative to the transport means, thus allowing the separating means to continuously interact with the holding members. It is advantageous if a safe interaction between the separating means and the retaining means is achieved by the geometric design of the separating means. “Interaction” means that the separating unit comes into direct or indirect physical contact with in each case at least one holding member via the at least one separating means, thus allowing the respective holding member to be moved from the in-line configuration into the separated configuration. The at least one separating means conveys the respective holding member actively. While it is moving, the respective separating member moves the respective holding member actively in the transport direction from the in-line configuration into the separated configuration. The separating means may follow a substantially circular or linear separating direction. The separating unit may further extend in a substantially horizontal or in a substantially vertical plane.

A transport system in which the separating unit is configured such as to periodically interact with the holding members for moving the same in the transport direction ensures a periodic interaction of the holding members with the at least one separating means of the separating unit during a continuous transport of the holding members.

A transport system in which the at least one separating means is movable relative to the transport means permits a defined and controllable interaction of the at least one separating means with the holding members.

A transport system in which the movement of the at least one separating means is driven by a separating drive allows the at least one separating means to be driven independently of the transport means, with the result that the movement of the separating means on the one hand and the movement of the transport means on the other are controllable independently of each other.

A transport system in which the separating unit comprises a driven means which engages with the transport means such that a drive of the transport means results in the movement of the at least one separating means provides for a simple and energy-saving design of the transport system since only one drive means is required for driving the transport means on the one hand and for driving the at least one separating means.

A transport system in which the separating unit has at least one separating means rotatable about an axis of rotation for interaction with the holding members provides for a high separation performance while minimizing the space required for installing the separating unit. It is advantageous if the separating unit has a rotating separating wheel. The separating wheel is provided with the at least one separating means. The separation performance is defined by a rotational speed of the separating wheel about the axis of rotation and the number of the separating means. Advantageously, all separating means are configured identically. For instance, all separating means comprise a circular breakthrough at the radial outer circumference of the rotating separating wheel. The separating wheel may also be configured in the shape of spokes.

A transport system in which the at least one separating means is movable along a circular path allows the at least one separating means to interact with a respective one of the holding members in a defined manner. When moving along the circular track, the at least one separating means engages with one of the holding members so as to transport said holding member along a portion of its circular track.

A transport system in which the separating unit comprises at least two separating means which are arranged at equal distances from each other relative to the axis of rotation provides a particularly simple solution for a periodic interaction of a respective separating means with a holding member.

A transport system in which the separating unit has at least one separating means which is movable along a substantially linear separating direction for interaction with the holding members provides a particularly simple manner of adapting the movement of the at least one separating means relative to the transport means.

A transport system in which the separating means interact with in each case two holding members at a time which are adjacent to each other in the transport direction, wherein a first holding member is transportable in the transport direction while a second holding member is retainable in the inline configuration, ensures that a first holding member is safely transported in the transport direction on the one hand and that a second holding member is reliably held back and oriented on the other. The at least one separating means interacts on the one hand with a respective holding member for moving the in-line configuration into the separated configuration, and with a respective holding member on the other in order to hold the holding member in the in-line configuration. Said interaction for moving one holding member from the in-line configuration into the separated configuration and said interaction for retaining another holding member is carried out preferably simultaneously by one and the same separating means.

Another object of the invention is to provide a method for transporting hanging goods which allows a considerably higher separating performance of a separating unit to be achieved while at the same time ensuring a reliable operation.

This object is achieved by a method for transporting hanging goods, said method comprising the method steps of providing a transport means for transporting holding members serving as hanging adapters for accommodating hanging goods; transporting the holding members in a transport direction towards a separating unit; and separating the holding members by moving the hanging goods by means of the separating unit such that there is a predefined distance between two adjacent pieces of goods. Providing a transport means for transporting holding members serving as hanging adapters for accommodating hanging goods, in particular in each case one piece of goods, by transporting the holding members in the transport direction to a separating unit, and separating said holding members from each other by moving the hanging goods by means of the separating unit such that a predefined distance is obtained between two adjacent holding members allows for a defined interaction of the separating unit with the holding members, with a separating performance being controllable preferably by actuating the separating unit.

A method in which the separating unit periodically interacts with the holding members so as to move the same in the transport direction from an undefined configuration, in which there is a first undefined distance between two adjacent holding members, into a separated configuration, in which there is the predefined distance between the two adjacent holding members, ensures a periodic interaction of in each case at least one separating means with one of the holding members such that distances between two respective holding members adjacent to each other in the transport direction are adjustable.

A method in which the movement of the separating unit is driven by a drive of the transport means is based on a particularly simple and energy-saving design.

A method in which a rotation of the separating means results in a linear movement of the holding members in the transport direction allows for a space-saving design of the separating unit.

Further features, advantages and details of the invention will be apparent from the ensuing description of exemplary embodiments.

### BRIEF DESCRIPTION OF THE DRAWING

FIG. 1 shows a schematic plan view of a transport system according to the invention;

FIG. 2 shows a side view of a portion of the transport system in FIG. 1 according to a first exemplary embodiment of a separating unit;

FIG. 3 shows a plan view of the portion of the transport system according to FIG. 2;

FIG. 4 shows a sectional view along section line IV-IV in FIG. 2;

FIG. 5 shows a side view of a portion of the transport system in FIG. 2 according to a second exemplary embodiment of a separating unit;

FIG. 6 shows a view of the transport system according to FIG. 5 from above, with a separating means of the separating unit being in a first position;

FIG. 7 shows a view similar to FIG. 6, with the separating means being in a second position and interacting with a retaining means;

FIG. 8 shows a view of the transport system similar to FIG. 6 and FIG. 7, with the separating means being in a third position and interacting with the holding member;

FIG. 9 shows a third exemplary embodiment of a separating unit with a separating means in a first position, said separating means interacting with two holding members;

FIG. 10 shows a view, similar to FIG. 9, of the third exemplary embodiment of the separating unit, with the separating means and the holding members being in a second position;

FIG. 11 shows a view, similar to FIG. 9 and FIG. 10, of the third exemplary embodiment of the separating unit, with the separating means and the holding members being in a third position;

FIG. 12 shows a view of a portion of a fourth exemplary embodiment of a separating unit, with a separating means being in a first position in which it does not interact with holding members;

FIG. 13 shows a view similar to FIG. 12, with the separating means being in a second position just before it comes to interact with the holding members; and

FIG. 14 shows a view similar to FIG. 12 and FIG. 13, with the separating means being in a third position between the holding members.

### DESCRIPTION OF THE PREFERRED EMBODIMENTS

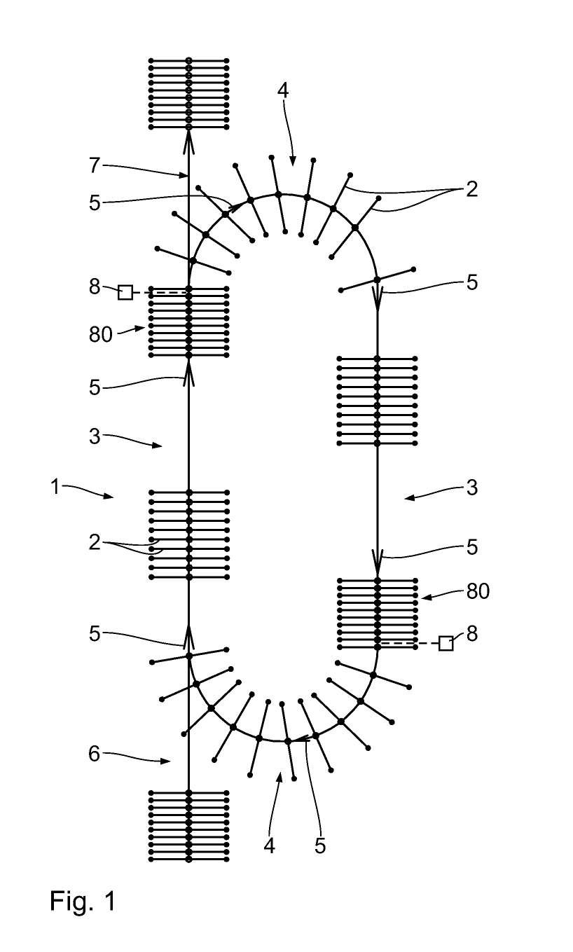

A transport system, designated as a whole by reference numeral 1 in FIG. 1, allows hanging goods 2 to be transported. The transport system 1 is substantially configured as a circulating conveyor system and comprises two accumulation zones 3 and two conveyor zones 4 interconnecting the accumulation zones 3. The accumulation zones 3 and conveyor zones 4 thus interconnected form an endless circulation path. The two accumulation zones 3 are each arranged linearly. The conveyor zones 4 are each arranged in the shape of a semi-circle. Throughout the transport system 1, the transport direction oriented in the clockwise direction is defined by the orientation of the accumulation zones 3 and the conveyor zones 4, in other words it allows for an endless circulation. The transport direction is indicated by the arrows 5.

The transport system 1 comprises a feed zone 6 allowing hanging goods 2 to be fed into the circulating conveyor consisting of the two accumulation zones 3 and the conveyor zones 4. The feed zone 6 is in particular connected to an outlet of the conveyor zone 4 shown at the bottom of FIG. 1.

Furthermore, a discharge zone 7 is provided, the discharge zone 7 allowing one to discharge hanging goods 2 to be discharged from the circulating conveyor. In order to feed in and/or discharge the hanging goods 2, switch members not shown in more detail are provided in the region of the feed zone 6 and the discharge zone 7.

A separating unit 8, which is only shown schematically in FIG. 1, is in each case provided between an accumulation zone 3 and a conveyor zone 4. The separating unit 8 defines a separation zone 80. Seen in the transport direction 5, the separation zone 80 is arranged between the accumulation zone 3 and the conveyor zone 4. The separating unit 8 allows the hanging goods to be separated from each other. In the following sections, the separating unit 8 will be explained in detail by means of four exemplary embodiments.

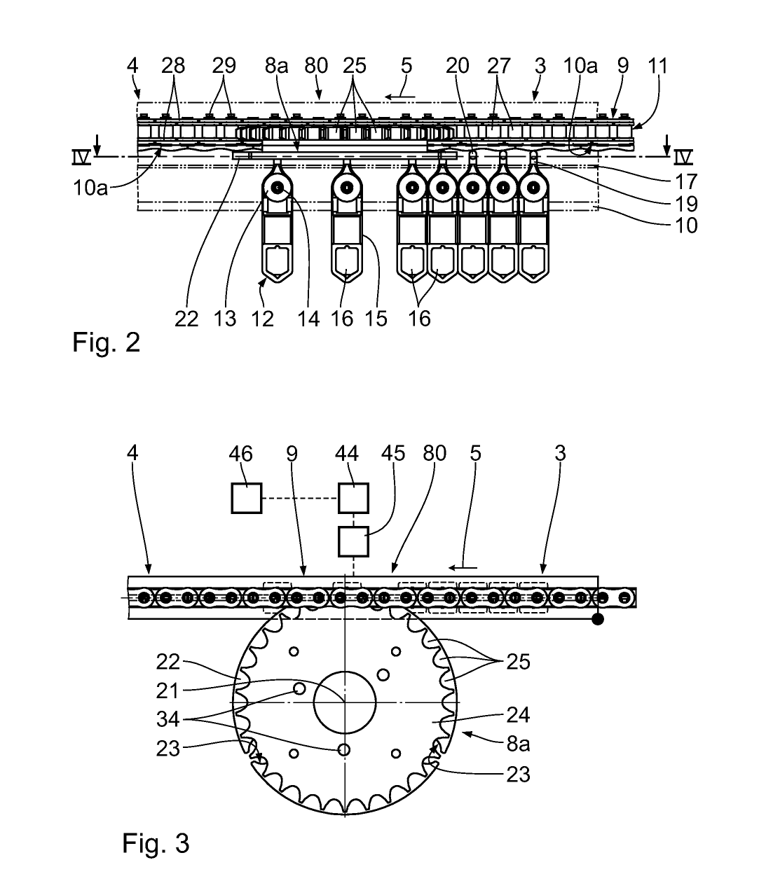

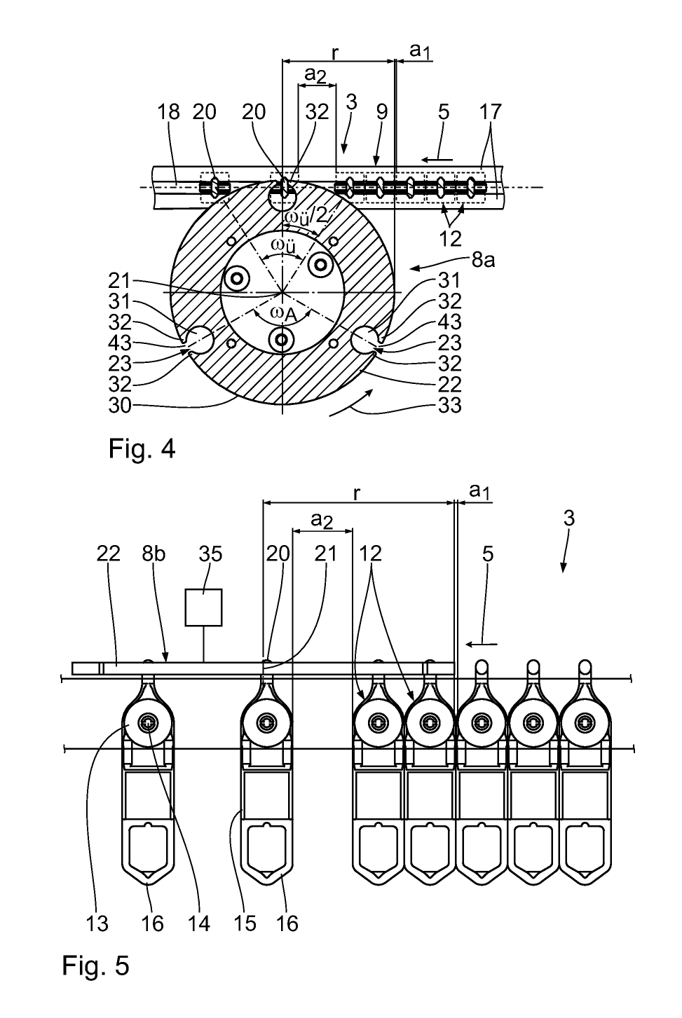

A first exemplary embodiment of a separating unit 8a is explained by means of FIG. 2, FIG. 3 and FIG. 4. FIG. 2, FIG. 3 and FIG. 4 also show a portion of the transport means 9 defining the transport direction 5. The transport means 9 of the transport system 1 comprises a transport rail 10 which can be installed three-dimensionally by means of suitable support devices. For the sake of clarity, the transport rail 10 is only indicated by dashed lines in the side view according to FIG. 2.

Above the transport rail 10, which is preferably configured in the manner of a box girder, a driving chain 11 is arranged which is drivable, by means of driving means not shown, in the substantially horizontal transport direction 5. The driving chain 11 is a roller chain of metal which has rollers 27 that are interconnected by means of connection lugs 28 and bolts 29 such that there is in each case a small distance between the rollers 27. The driving chain 27 is driven such that the rollers 27 move in the transport direction 5. The driving chain 11 may for instance be driven by means of a drive motor known per se, such as an electric motor or the like.

The partial view according to FIG. 2 shows the accumulation zone 3 and the conveyor zone 4, wherein a transport rail 10—indicated by a dash-dotted line—comprising a driving chain 11 runs both in the accumulation zone 3 and in the conveyor zone 4. The separating unit 8a separates the accumulation zone 3 from the conveyor zone 4 in the transport direction 5.

Furthermore, holding members 12 are provided which are adapted to be transported along the transport rail 10. The holding members 12 are adapted to carry the hanging goods 2. In the illustrated exemplary embodiment of the transport system 1, the holding members 12 are conveyed in the transport direction 5 to the accumulation zone 3 by means of a carrier 10a. The carrier 10a is arranged at a lower side of the driving chain 11 such as to face the holding members 12. The carrier 10a is flat in a vertical direction and extends in the transport direction 5. Seen in the transport direction 5, the carrier 10a has a wavelike design with a plurality of peaks and troughs which are arranged in the transport direction 5 in a periodically alternating manner, in particular such as to follow a sinusoidal curve. The wavelike carrier 10a provides a combined frictional/positive engagement for actively conveying the holding members 12.

Alternatively, it is conceivable to provide, instead of the carrier 10a, a passive transport of the holding members 5 in the transport direction 5, for instance by means of gravity. The conveyor zones 4 are thus configured as passive sliding zones suitable for transport under the effect of gravity. To this end, the transport rail 10 is inclined relative to the horizontal in the conveyor zones 4.

Seen in the transport direction 5, the separating unit 8a is provided with another wavelike carrier 10a. The two carriers 10a are configured identically. The carrier 10a shown on the left-hand side of the separating unit 8a is used to move the holding members 12 out of the separating unit 8a.

Each of the holding members 12 is provided with rollers 13 which are each supported on guide webs of the transport rail 10 such as to roll thereon in the transport direction 5. In other words, one pair of rollers 13 is provided for in each case one holding member 12, said rollers 13 being rotatable about a common axis of rotation 14 such that the entire holding member 12 is able to rotate or swing about the axis of rotation 14 in the transport rail 10. Between the guide webs of the transport rail 10, a lower slot extending in the transport direction 5 is formed through which a flat carrier member 15 of each holding member 12 protrudes downwardly from the transport rail 10. At its lower end, the carrier member 15 has an accommodation opening 16 adapted to accommodate a hook of a hanger (not shown) carrying for instance a piece of goods 2 in the form of a piece of clothing or a bag to be transported.

Directly above the rollers 13, the transport rail 10 has horizontal barrier webs 17 facing each other, said barrier webs 17 defining an upper slot 18 between each other which is in particular visible in the sectional view according to FIG. 4. A stick-like projection 19 of the holding member 12 formed in one piece with the upper end of the carrier member 15 extends through said slot 18. At the upper end of the projection 19, a stop 20 in the manner of a cross-bar is formed which has an extension in a horizontal direction transverse to the transport direction 5 that is greater than the width of the slot 18.

The separating unit 8a is shown in a side view according to FIG. 2 and in a view from above according to FIG. 3. The separating unit 8a comprises a separating wheel 22 with three separating means 23, the separating wheels 23 being rotatable about an axis of rotation 21. The separating means 23 are therefore rotatable about the axis of rotation 21 as well and are able to interact with the holding members 12. The separating means 23 are movable along a circular path. The rotating separating wheel 22 is arranged horizontally, with the axis of rotation 21 of the separating wheel 22 extending transversely to the transport direction 5.

The separating wheel 22 is connected to a driven means 24 in the form of a driven pulley such as to co-rotate therewith, wherein said driven pulley is rotatable about the axis of rotation 21 as well and has notches 25 at its outer circumference the contour of which is matched to an outer contour of the rollers 27 of the driving chain 11.

The driven pulley 24 is rotatable about the axis of rotation 21 by the movement of the rollers 27 of the driving chain 11 in the transport direction 5 and the engagement of the rollers with the notches 25 of the driven pulley 24. As the driven pulley 24 is connected to the separating wheel 22 such as to co-rotate therewith, the separating wheel 22 comprising the separating means 23 is therefore rotatable about the axis of rotation 21 by means of the driving chain 11 as well. An arrangement of this type is particularly efficient in terms of energy and resources as the separating unit 8a does not require a separate drive system.

As can be seen from FIG. 3, the separating wheel 22 protrudes beyond the driven pulley 24 in a radial direction relative to the axis of rotation 21. This ensures a trouble-free interaction of the separating means 23 with the holding members 12.

The separating means 23 are arranged at equal distances from each other relative to the axis of rotation 21. The separating means 23 have an angular distance ω_{A} from each other relative to the axis of rotation 21. In the first embodiment of the separating unit 8a, the angular distance ω_{A} amounts to in each case 120°. By rotation of the separating wheel 22, the separating means 23 are movable relative to the transport means 9. The equal distance provided between the individual separating means 23 allows for a periodic interaction of the separating means 23 with a respective one of the holding members 12 in order to move the respective holding member 12 in the transport direction 5.

As can in particular be seen from FIG. 4, the separating means 23 according to the first embodiment of the separating unit 8a are each formed by a breakthrough 31 at the radial outer circumference of the rotating separating wheel 22 and by in each case two hook-shaped protrusions 32. Each of the hook-shaped protrusions 32 shows in the circumferential direction relative to the axis of rotation 21.

The separating means 23 are each configured identically. The breakthroughs 31 of the separating means 23 each extend from an outer edge 30 of the separating wheel 22 in the direction of the axis of rotation 21. As can in particular be seen from FIG. 4, in the exemplary embodiment of the separating unit 8a, the breakthroughs 31 extend inwardly from the outer edge 30 in the direction of the axis of rotation 21 by less than half the radius r of the separating wheel 22. Each of the breakthroughs 31 has a circular contour which is connected to the outside via a carrier groove 43.

The separating unit 8a is arranged relative to the transport means 9 such that when the separating means 23 are moved along the circular path in a direction of rotation 33, exactly one separating means 23 interacts with a respective one of the holding members 12. The separating means 23 is able to accommodate the holding member 12 in the region of the stop 20 of the projection 19. The separating means 23 ensures a guided displacement of the respective holding member 12. While it is moving along the circular path, the respective separating means 23 moves the respective retaining means 12 in the transport direction 5 from an undefined configuration in the accumulation zone 3, in which there is a first distance a₁ between two adjacent holding members 12, into a separated configuration in the separation zone 80 in which there is a second, predefined distance a₂ between the two adjacent holding members 12. As illustrated, the second distance a₂ is greater than the first distance a₁. The second distance a₂ may however also be smaller than the first distance a₁.

In the illustrated exemplary embodiment, the first distance a₁ is in particular smaller than the second distance a₂ because no hanging goods are attached to the holding members 12. The holding members 12 are unloaded. This means that in the accumulation zone 3 according to FIG. 5, the holding members 12 have a first minimum distance a₁ₘᵢₙ from each other. If each of the holding members 12 carries a respective piece of goods 2, then the first distance a₁ in the accumulation zone 3 is generally greater than the first minimum distance a₁ₘᵢₙ which is based on the width, oriented in the transport direction 5, of the holding members 12. In each case, the first distance a₁ between two adjacent holding members 12 in the accumulation zone 3 is unknown and in particular undefined. In this configuration, an error-free and reliable identification of the holding members 12, strictly speaking the hanging goods 2 attached thereto, is not possible without additional effort. Correspondingly, the holding members 12 of FIG. 4 arranged in a row in the accumulation zone 3 when seen in the transport direction 5 have the first distance a₁ from each other.

When interacting with the respective holding member 12, the separating means 22 engage with the stick-like projection 19 thereof in the region of the stop 20, wherein the respective hook-shaped protrusion 32 may come to abut against the stop 20. When the holding member 12 is being moved from the in-line configuration into the separated configuration, the stop 20 is in the region of the carrier groove 43 between the hook-shaped protrusions 32 of the separating means 23.

In the first exemplary embodiment of the separating unit 8a, in each case one separating means 23 interacts with a holding member 12 in the angular region cop while it is rotating in the direction of rotation 33. The dimensions of the separating means 23, in particular those of the carrier groove 43, need to be adapted to the stops 20 of the holding members 12 such that when the separating means 23 rotates in the direction of rotation 33, it automatically takes up the respective holding member 12 from the in-line configuration and automatically releases the same as soon as the separated configuration is reached. Between take-up and release of the respective holding member 12, the separating means 23 travels across the angle cop relative to the axis of rotation 21.

The functioning of the transport system 1 for transporting hanging goods 2 by means of the separating unit 8a is as follows:

In a first step, the transport means 9 for transporting the hanging goods 2 in the transport direction 5 is provided. Then hanging goods 2 are fed to the transport system 1 via the feed zone 6. The hanging goods 2 are at first moved to the accumulation zone 3. A transport of the hanging goods 2 in the transport direction 5 towards the accumulation zone 3 takes place as explained above by means of a transport rail 10, inclined relative to the horizontal, of the transport means 9. In the accumulation zone 3, the holding members 12 have the distance a₁ relative to each other in the transport direction 5. The first distance a₁ between the holding members 12 in the accumulation zone 3 may be different, in particular if different hanging goods 2 are attached to the respective holding members 12. The holding members 12, and therefore the hanging goods 2, are accumulated either by means of a suitable accumulation means (not shown), for instance a stopper, which is movable transverse to the transport direction 4 or simply by ensuring that the transport rail 10 extends horizontally in the accumulation zone 3. In this case, the transport rail 10 is inclined relative to the horizontal only in a portion between the feed zone 6 and the accumulation zone 3.

In the next step, the hanging goods 2 are separated from each other by moving the hanging goods 2 by means of the separating unit 8a such that there is the predefined second distance a₂ between two adjacent hanging goods 2. As already explained above, the separating means 23 of the separating unit 8a periodically interact with the holding members 12 such that the separating means 23 move a respective holding member from the in-line configuration, in which there is the first distance a₁ between two adjacent holding members 12, into the separated configuration in which there is the second distance a₂ between two adjacent holding members 12.

While one of the holding members 12 is being transported by a respective separating means 23, a holding member 12 following the transported holding member 12 abuts against an outer edge 30 of the separating wheel 22 in the accumulation zone 3. The separating wheel 22 of the separating unit 8a fulfils a retaining function. The separating means 23 of the separating unit 8a each fulfil a transport function for the holding members 12. When the separating unit 8a continues to rotate in the direction of rotation 33, the previously retained holding member 12 is accommodated for transport by a subsequent separating means 23.

In the embodiment of the separating unit 8a according to FIG. 2 to FIG. 4, the holding members 12 have the distance a₂ from each other as soon as a separating means 23 interacting with one of the holding members 12 has rotated about the angle cop after accommodating the respective retaining means 12, and as soon as the separating means 23 has released the respective holding member 12 after reaching the separated configuration. FIG. 4 shows a holding member 12 having been moved to the separated configuration by means of a separating means 23. FIG. 4 further shows another holding member 12 interacting with a separating means 23, said separating means 23 having travelled across the angle ω₀/2 after accommodating said holding member 12.

The predefined distance a₂ allows a holding member 12 in the separated configuration to be read out in the respective separating means 23. To this end, an identification unit 44 is provided which is shown schematically in FIG. 3, said identification unit 44 comprising a reading device 45 allowing an identification code provided at the holding member 12 to be read out, said identification code being assigned to the hanging goods 2. Preferably, the identification code of the holding member 12 is read out in the 12 o'clock position of the separating wheel 22 shown in FIG. 4. It is conceivable as well to read out the identification code in another position of the holding member 12. Alternatively, it is conceivable as well to read out the identification code while the respective holding member 12 is being moved form the in-line configuration to the separated configuration.

According to the illustrated embodiment, the holding members 12 are provided with an RFID chip carrying the identification code. Correspondingly, the identification unit 44 is configured as an RFID reading unit. The hanging goods 2 carried by the holding members 12 may also be provided with a transponder. The identification unit 44 is then configured as a transponder reader. Alternative configurations of the identification unit 44 are conceivable as well, the identification code of the hanging goods 2 then being configured correspondingly. In particular, a switch member associated to the discharge zone 7 and the identification unit 44 are in signal communication with a control device 46. It is possible to actuate the switch member depending on the respective identification code, in particular to allow one or several hanging goods 2 to be removed from the circulating conveyor in a defined manner.

As explained above with reference to FIG. 1, when seen in the transport direction 5, the accumulation zone 3 is—depending on a position of the switch—adjoined by the discharge zone 7 or the conveyor zone 4. Depending on the design of the transport system 1, the holding members 12 in the discharge zone 7 or in the conveyor zone 4 are either actively conveyable, for instance by means of the carrier 10a provided at the driving chain 11, or the discharge zone 7 and the conveyor zone 4 are configured as passive gravity conveyors. A gravity conveyor of this type has an inclination relative to the horizontal such that the holding members are automatically conveyed along the gravity conveyor as a result of gravity. An active drive system is not required. Said gravity conveyance is facilitated by the fact that the holding members 12 roll, via the rollers 13, in a transport rail provided for this purpose of the gravity conveyor.

The distance a₂ in the separated configuration is adjustable by variation and configuration of the separating means 23. As such the distance a₂ is for instance changeable by changing the angular distance ω_{A} of the separating means 23 relative to the axis of rotation 21. For instance, it is conceivable to provide various rotatable separating wheels 22 which are each detachably mountable to the driven pulley 24 according to requirements. For this purpose, the separating wheel 2 is detachably connected to the driven pulley 24 by means of fastening means 34. The fastening means 34 may for instance be configured as screw connections or the like.

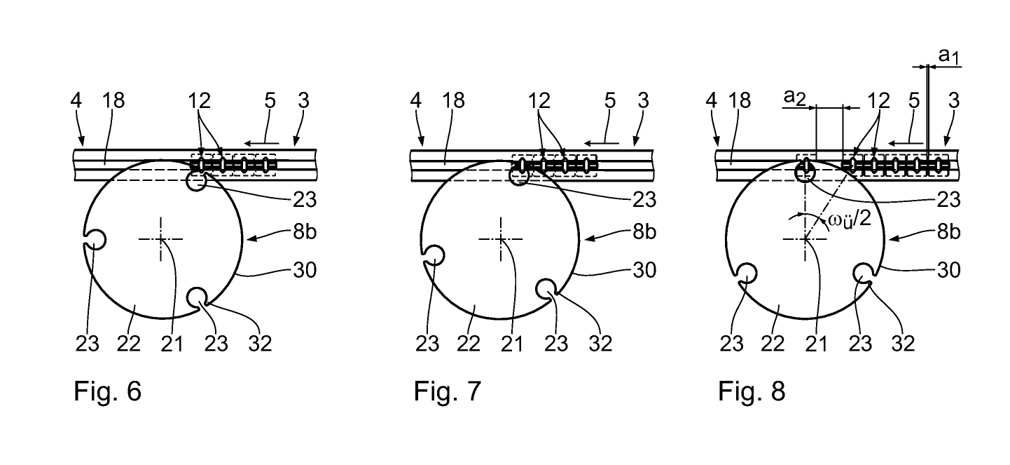

In the following sections, a second embodiment of a separating unit 8b for use in a transport system 1 according to FIG. 1 will be described with reference to FIG. 5, FIG. 6, FIG. 7 and FIG. 8. Components that differ from those in the first embodiment of the separating unit 8a in terms of their design but have the same function are designated by the same reference numerals followed by the letter b. Identical components are designated by the same reference numerals.

The separating unit 8b primarily differs from the separating unit 8a in that the separating unit 8b is not provided with a driven pulley. The essential component of the separating unit 8b is the separating wheel 22 which is provided with the separating means 23. The separating wheel 22 and the separating means 23 are identical to the corresponding components of the first embodiment of the separating unit 8a.

The movement of the separating wheel 22, and therefore of the separating means 23, about the axis of rotation 21 is driven by a separating drive 35 shown schematically in FIG. 5. The separating drive 35 may for instance be a drive motor known per se, for instance an electric motor, which causes the separating wheel 22 to rotate about the axis of rotation 21 by means of a drive shaft. Alternatively, a belt arrangement may be provided to ensure an effective transmission of forces. The movement of the separating means 23 is independent of a drive of the transport means 9. In this embodiment of the separating unit 8b according to FIG. 5 to FIG. 8, a transport means 9 comprising a driving chain 11 as described with reference to FIG. 2 to FIG. 4 may be omitted.

The functioning of the separating unit 8b for moving in each case one holding member 12 from the in-line configuration into the separated configuration corresponds to the functioning of the separating unit 8a described above. FIG. 6, FIG. 7 and FIG. 8 illustrate the different stages of interaction between a separating means 23 and a holding member 12. FIG. 6 shows the holding member 12, which is in the foremost position in the accumulation zone 3 when seen in the transport direction 5, in an instant in which the holding member 12 has the distance a₁ from the holding member 12 adjacent thereto in the transport direction 5 just before it comes into engagement with the hook-shaped protrusions 32 of a separating means 23. In FIG. 7, the holding member 12 has then been taken up by the separating means 23 and passes through the carrier groove 43. FIG. 8 shows the holding member 12 after said holding member 12 has been carried by the separating means 23 such as to travel along the path a₂/2 in the transport direction 5, with the separating means 23 then having rotated through the angle ω₀/2 after having taken up said holding member 12.

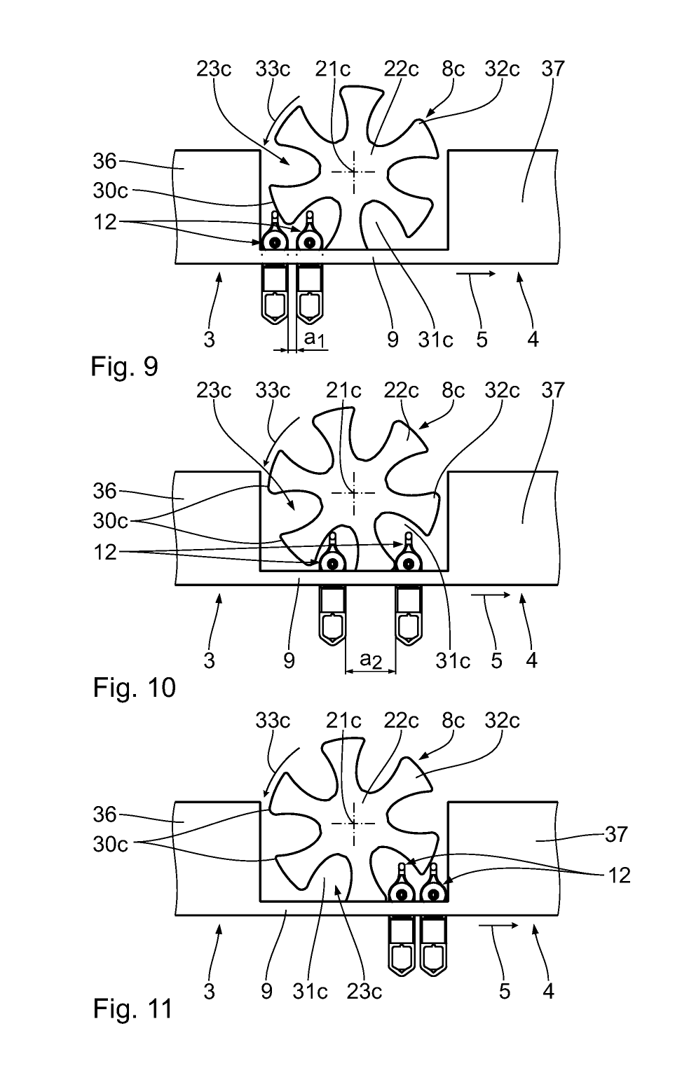

In the following sections, a third embodiment of a separating unit 8c for use in a transport system 1 according to FIG. 1 will be described with reference to FIG. 9, FIG. 10 and FIG. 11. Components that differ from those in the first embodiment of the separating unit 8a in terms of their design but have the same function are designated by the same reference numerals followed by the letter c. Identical components are designated by the same reference numerals.

An essential difference between the third embodiment of the separating unit 8c and the previously described separating units 8a, 8b is that the axis of rotation 21c extends horizontally and transversely to the transport direction 5. The separating unit 8c is arranged above the hanging goods 2 and above the transport means 9. The previously described separating units 8a, 8b are arranged laterally with respect to the transport means 9 and laterally with respect to the transport direction 5.

The separating unit 8c comprises a separating wheel 22c which is driven for rotation about the axis of rotation 21c in the direction of rotation 33c.

The separating wheel 22c is driven by a separating drive not shown in FIG. 9, FIG. 10 and FIG. 11. The separating drive may for instance be a drive motor known per se, for instance an electric motor.

Separating means 23 comprise breakthroughs 31c, said breakthroughs 31c extending from an outer edge 30c radially in the direction of the axis of rotation 21c. According to the embodiment illustrated in FIG. 9, FIG. 10 and FIG. 11, the separating wheel 22c of the separating unit 8c comprises six separating means 32c which are arranged at equal distances from each other relative to the axis of rotation 21c. Seen in the circumferential direction relative to the axis of rotation 21c, two breakthroughs each are separated from each other by a protrusion 32c extending radially away from the axis of rotation 21.

FIG. 9 shows two holding members 12 which are arranged in the accumulation zone 3 at a distance a₁ from each other when seen in the transport direction 5. By means of the separating unit 8c, the holding members 12 are movable in the transport direction 5 from a first processing station 36 into a second processing station 37, with the hanging goods 2, strictly speaking the holding members 12, being separated from each other between the first processing station 36 and the second processing station 37 when seen in the transport direction 5. FIG. 9 shows the separating wheel 22c just before it comes to interact with the holding member 12 arranged in the accumulation zone 3 in the foremost position when seen in the transport direction 5. Said holding member 12 passes through a breakthrough 31c between two protrusions 32c already partly.

In FIG. 10, the separating wheel 22c has already rotated about the axis of rotation 21c through an angle of 60° such that a first separating means 23c has come into contact with the first holding member 12 via the protrusions 32c for linear transport of said holding member 12 in the transport direction 5. Due to a rotation of the separating wheel 22c in the direction of rotation 33c, the second separating means 23c adjacent to the first separating means 23c when seen in the direction of rotation 33c has come into engagement with the second holding member 12, causing said second holding member 12 to be moved along a portion in the transport direction 5 as well. The design of the separating wheel 22c also allows two separating means 22c at a time to interact with in each case one holding member 12 so as to move said holding member 12 from an in-line configuration into a separated configuration. In the configuration according to FIG. 10, the holding members 12 have the distance a₂ from each other when seen in the transport direction 5. In this arrangement, it is possible for an identification unit to read out an identification code of the hanging goods 2 as explained above with reference to the separating unit 8a. Depending on the detected identification code, the respective piece of goods 2 is adapted to be further processed in the second processing station 37. It is conceivable to actuate the second processing station 37 depending on the detected identification code. The processing station 37 may for instance be a removal station or a packaging station. FIG. 11 shows another view of the holding members 12 arranged such as to have the first distance a₁ from each other again. Preferably, the respective protrusion 32c conveys the holding members 12 in the transport direction 5 and into the second processing station 37 by a rotation thereof.

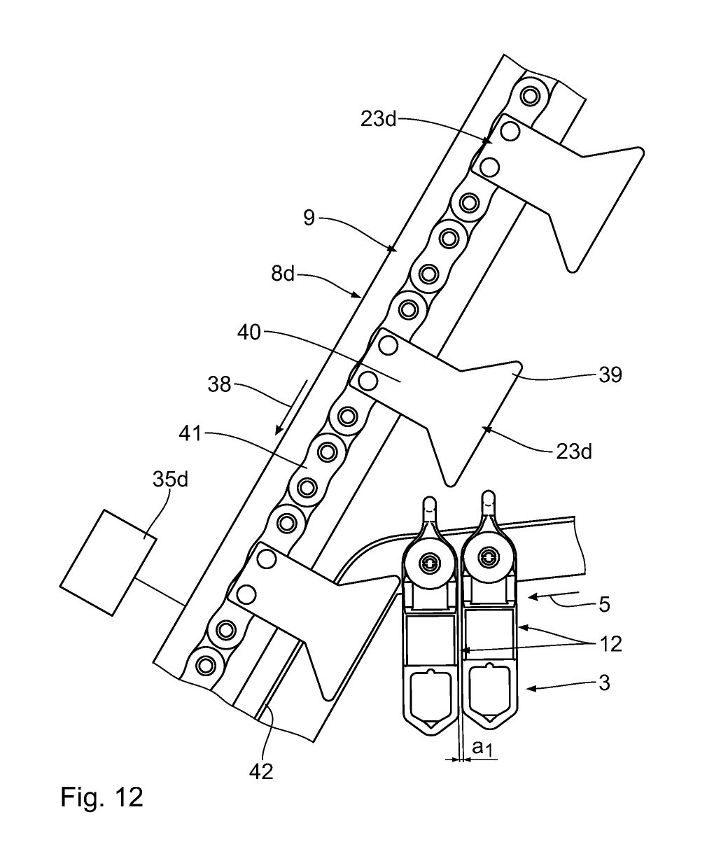

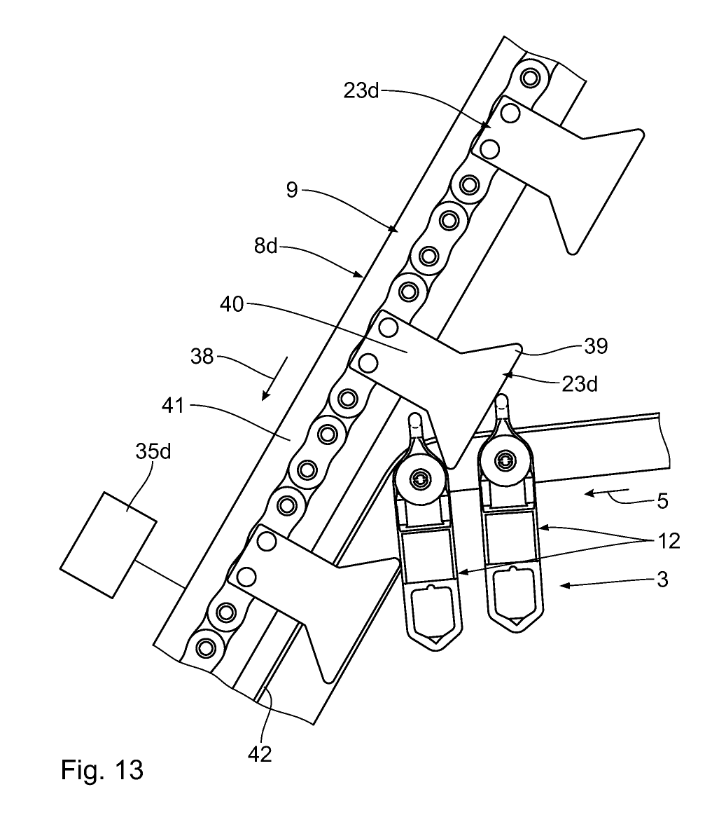

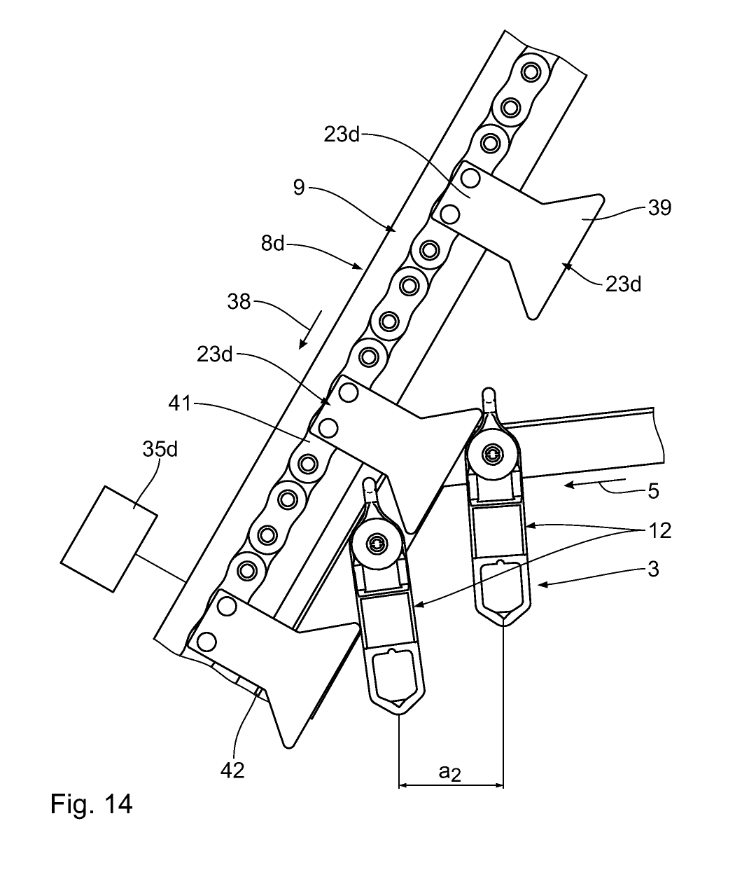

A fourth embodiment of a separating unit 8d will be described with reference to FIG. 12, FIG. 13, and FIG. 14. Components that differ from those in the first embodiment of the separating unit 8a in terms of their design but have the same function are designated by the same reference numerals followed by the letter d. Identical components are designated by the same reference numerals.

The separating unit 8d differs from the separating unit 8a, 8b, 8c explained above in that separating means 23d are movable in a linear separating direction 38 for interaction with the holding members 12.

According to the embodiment of the separating unit 8d, the separating means 23d are configured as approximately T-shaped carriers comprising a cross-web 39 for interaction with the holding members 12 and a longitudinal web 40 attached to a separating means transport device 41 of the separating unit 8d. The transport device 41 is preferably configured as a conveyor chain to which the separating means 23d are detachably mounted. The separating means transport device 41 preferably has a separating drive 35d which is shown schematically in FIG. 12, FIG. 13, and FIG. 14. The separating drive 35d may for instance be a drive motor known per se, for instance an electric motor.

In FIG. 12, the holding members 12 are shown in the accumulation zone 3, with the holding members 12 having the distance a₁ from each other in the transport direction 5. In order to move a holding member 12 from an in-line configuration into a separated configuration, the holding member 12 interacts, as shown in FIG. 13, with two holding members 12 at a time which are adjacent to each other in the transport direction 5, wherein a first holding member 12 is transportable in the transport direction 5 while a second holding member 12 can be retained in the in-line configuration. When the separating means 23d are moved along the separating unit 38, the first holding member 12 is carried along temporarily in the transport direction 5, allowing the holding member 12 to be transported to an inclined path 42 where it is continued to be transported in the transport direction 5 under the effect of gravity. As can be seen from FIG. 14, just before the first holding member 12 enters the inclined path 42, the holding members 12 have the second distance a₂ from each other, thus allowing an identification unit to read out an identification code of the respective piece of goods 2 corresponding to the embodiments described above.

All four embodiments of the separating unit 8a, 8b, 8c, 8d have the effect that compared to known separating units, a higher separating performance is achievable. By actuating the respective separating means 23a, 23b, 23c, 23d, the separating performance can be set as required. The respective separating unit 8a, 8b, 8c, 8d to be used depends on the three-dimensional layout of the transport system 1.

What is claimed is:

1. A transport system for transporting hanging goods (2), comprising
a transport means (9) defining a transport direction (5),
several holding members (12) transportable at the transport means (9) in the transport direction (5), said holding members (12) being configured as hanging adapters for accommodating hanging goods (2), and
at least one separating unit (8a; 8b; 8c; 8d) for separating the holding members (12), wherein
the separating unit (8a; 8b; 8c; 8d) has at least one separating means (23a; 23b; 23c; 23d),
in each case one separating means (23a; 23b; 23c; 23d) interacts with at least one holding member (12) for moving the same from an undefined configuration into a separated configuration,
in the separated configuration, there is a predefined distance (a₂) between two adjacent holding members (12).

2. A transport system according to claim 1, wherein the separating unit (8a; 8b; 8c; 8d) is configured such as to periodically interact with the holding members (12) for moving the same in the transport direction (5).

3. A transport system according to claim 1, wherein the at least one separating means (23a; 23b; 23c; 23d) is movable relative to the transport means (9).

4. A transport system according to claim 1, wherein the movement of the at least one separating means (23a; 23b; 23c; 23d) is driven by a separating drive (35).

5. A transport system according to claim 1, wherein the separating unit (8a) comprises a driven means (24) which engages with the transport means (9) such that a drive of the transport means (9) results in the movement of the at least one separating means (23a).

6. A transport system according to claim 1, wherein the separating unit (8a; 8b; 8c) has at least one separating means (23a; 23b; 23c) rotatable about an axis of rotation (21) for interaction with the holding members (12).

7. A transport system according to claim 6, wherein the at least one separating means (23a; 23b; 23c) is movable along a circular path.

8. A transport system according to claim 6, wherein the separating unit (8a; 8b; 8c) comprises at least two separating means (23a; 23b; 23c) which are arranged at equal distances from each other relative to the axis of rotation (21).

9. A transport system according to claim 1, wherein the separating unit (8d) has at least one separating means (23d) which is movable along a substantially linear separating direction (38) for interaction with the holding members (12).

10. A transport system according to claim 1, wherein the separating means (23c; 23d) interact with in each case two holding members (12) at a time which are adjacent to each other in the transport direction (5), wherein a first holding member (12) is transportable in the transport direction (5) while a second holding member (12) is retainable in the in-line configuration.

11. A method for transporting hanging goods (2), comprising the method steps of:
a. providing a transport means (9) for transporting holding members (12) serving as hanging adapters for accommodating hanging goods (2);
b. transporting the holding members (12) in a transport direction (5) towards a separating unit (8a; 8b; 8c; 8d);
c. separating the holding members (12) by moving the hanging goods (2) by means of the separating unit (8a; 8b; 8c; 8d) such that there is a predefined distance (a₂) between two adjacent pieces of goods (2).

12. A method according to claim 11, wherein the separating unit (8a; 8b; 8c; 8d) periodically interacts with the holding members (12) so as to move the same in the transport direction (5) from an undefined configuration, in which there is a first undefined distance (a₁) between two adjacent holding members (12), into a separated configuration in which there is the predefined distance (a₂) between the two adjacent holding members (12).

13. A method according to claim 11, wherein the movement of the separating unit (8a; 8b; 8c; 8d) is driven by a drive of the transport means (9).

14. A method according to claim 11, wherein a rotation of the separating means (8a; 8b; 8c) results in a linear movement of the holding members (12) in the transport direction (5).
